(19) United States
(12) Patent Application Publication
(10) Pub. No.: US 2025/0149267 A1
(43) Pub. Date: May 8, 2025

(54) Switching Apparatus

(71) Applicant: Alps Alpine Co., Ltd., Tokyo (JP)

(72) Inventor: Naoki HOSHI, Miyagi-ken (JP)

(21) Appl. No.: 19/010,332

(22) Filed: Jan. 6, 2025

Related U.S. Application Data
(63) Continuation of application No. PCT/JP2023/008046, filed on Mar. 3, 2023.

(30) Foreign Application Priority Data
Jul. 20, 2022 (JP) 2022-115453

(51) Int. Cl. H01H 5/06; H01H 13/04; H01H 13/32; H01H 13/78

(52) U.S. Cl. CPC H01H 5/06; H01H 13/04; H01H 13/32; H01H 13/78

(57) ABSTRACT

A switching apparatus includes a switching contact member, a common contact member, a movable contact member, and a holding member. The movable contact member includes a main body, a pair of contact pieces juxtaposed so as to clamp the switching contact member, and a common contact portion that comes into contact with the common contact member. The holding member includes a housing portion configured to house a housed portion of the main body, and when the housed portion is snap-fitted into the housing portion, the holding member restricts, for the main body, at least one of displacement in a direction along the moving direction of the movable contact member and displacement in a direction perpendicular to the moving direction while allowing a predetermined displacement in a direction perpendicular to both of the directions.

### CLAIM OF PRIORITY

This application is a Continuation of International Application No. PCT/JP2023/008046 filed on Mar. 3, 2023, which claims benefit of Japanese Patent Application No. 2022-115453 filed on Jul. 20, 2022. The entire contents of each application noted above are hereby incorporated by reference.

### BACKGROUND OF THE INVENTION

### 1. Field of the Invention

The present invention relates to a switching apparatus.

### 2. Description of the Related Art

International Publication No. 2019/230079 discloses a switching apparatus including a housing including a housing portion, an operating member that receives a pressing operation, multiple fixed contact points juxtaposed at predetermined intervals in the housing portion, multiple movable contact points including contact points that are in sliding-contact with the fixed contact points, and a snap-action mechanism that drives the movable contact points when the operating member is pressed to a predetermined position.

In the switching apparatus, the connection state is switched by the movement of the movable contact members relative to the switching contact member. Therefore, the relative positional relationship between the switching contact member and the movable contact members is important for ensuring reliable switching operation. For this reason, the movable contact members and a holding member are integrated using insert molding. However, it is preferable that the relative position of the switching contact member and the movable contact members be aligned easily and reliably without using insert molding.

### SUMMARY OF THE INVENTION

The present invention provides a switching apparatus configured to align the relative position of the switching contact member and the movable contact members easily and reliably.

A switching apparatus according to an embodiment of the present invention includes a switching contact member including at least two contact points, a common contact member, a movable contact member disposed between the switching contact member and the common contact member and configured to electrically connect the switching contact member and the common contact member to each other, and a holding member that holds the movable contact member, wherein the movable contact member moves relative to the switching contact member to allow for switching between a first connection state and a second connection state, wherein, in the first connection state, when a direction along a moving direction of the movable contact member is defined as a first direction, a direction along a direction in which the movable contact member extends and perpendicular to the first direction is defined as a second direction, and a direction perpendicular to both the first direction and the second direction is defined as a third direction, the movable contact member includes a main body, a pair of contact pieces provided at the main body, the contact pieces extending along the second direction and juxtaposed in the third direction so as to clamp the switching contact member, and a common contact portion provided at a portion of the main body different from a portion where the pair of contact pieces is provided, the common contact portion coming into contact with the common contact member, and the holding member includes a housing portion configured to house a housed portion of the main body, wherein, when the housed portion is snap-fitted into the housing portion, the holding member restricts, for the main body, at least one of displacement in the first direction and displacement in the second direction while allowing a predetermined displacement in the third direction.

With this configuration, the displacement of the main body relative to the holding member is restricted by the snap-fitting of the housed portion of the main body into the housing portion of the holding member. In this snap-fitting, the direction in which the main body is moved relative to the holding member for snap-fitting and the moving direction of the housed portion when housed into the housing portion by the snap-fitting cross at right angles. Therefore, the third direction is not concerned with the series of movement for the snap-fitting. For this reason, even in snap-fitting, the main body may be displaced in the third direction relative to the holding member.

In the switching apparatus, the holding member may further include a slit that restricts displacement of the main body in a moving direction of the housed portion when the housed portion is housed in the housing portion, and when the housed portion is snap-fitted into the housing portion, with an insertion portion of the main body different from the housed portion inserted into the slit, the displacement of the main body in the first direction and the displacement in the second direction relative to the holding member may be restricted. Thus, the snap-fitting, with the insertion portion inserted into the slit to restrict the displacement of the main body in the moving direction of the housed portion, reduces the possibility of the housed portion detaching from the housing portion.

In the switching apparatus, a moving direction of the housed portion when the housed portion is snap-fitted into the housing portion may be along the first direction. This configuration allows the movement of the movable contact member in the second direction to be restricted by snap-fitting.

In the switching apparatus, a moving direction of the housed portion when the housed portion is snap-fitted into the housing portion may be along the second direction. This configuration allows the movement of the movable contact member in the first direction to be restricted by snap-fitting.

The switching apparatus may further include an urging structure that urges the housed portion so as to come into elastic-contact with the housing portion, with the housed portion snap-fitted in the housing portion. When the housed portion and the housing portion are elastically connected in this manner, a force greater than the frictional force due to the elastic-contact is required to displace the housed portion in the housing portion. For this reason, the main body is not displaced relative to the holding member even under some vibrations, preventing lack of contact stability due to vibrations.

In the switching apparatus, the housed portion and the housing portion may come into elastic-contact with each other along the first direction. Since the urging direction of the urging structure 190 is along the first direction, the influence of the sliding resistance at the switching operation is reduced or eliminated.

In the switching apparatus, the holding member may include a plurality of the housing portions, the main body may include a plurality of the housed portions corresponding to the plurality of housing portions, and when the plurality of housed portions is snap-fitted into the corresponding housing portions, the displacement of the main body relative to the holding member in the first direction and in the second direction may be restricted. Thus, the main body may be held relative to the holding member via multiple snap-fittings.

In the switching apparatus, the holding member may include a restricting portion that restricts a range of displacement of the movable contact member relative to the holding member in the third direction. Since the movable contact member can be displaced in the third direction, separation in this direction can be minimized or eliminated by restricting the range of displacement in the third direction with the restricting portion.

In the switching apparatus, the restricting portion may include an intercalated portion positioned in a gap in the third direction between the pair of contact pieces. Since the intercalated portion comes into contact with the contact pieces, displacement of the movable contact member in the third direction can be minimized or eliminated.

In the switching apparatus, the urging structure may include a protrusion provided at the holding member and an engaging piece provided at the main body and integrally connected to the housed portion, wherein the protrusion and the engaging piece may be engaged with each other by movement of the housed portion when the housed portion is snap-fitted into the housing portion to cause elastic deformation of the engaging piece due to the protrusion, and the housed portion integrally connected to the engaging piece may be urged in the first direction by the elastic deformation. This configuration allows the housed portion to be urged in the first direction when snap-fitted to suppress the wobbling of the movable contact member in the first direction after snap-fitting.

In the switching apparatus, the protrusion may include an inclined surface, and the engaging piece may slide along the inclined surface as the housed portion moves to be snap-fitted into the housing portion, increasing a degree of the elastic deformation of the engaging piece. This configuration may increase the urging force that the engaging piece undergoes when the housed portion moves during snap-fitting.

In the switching apparatus, when the housed portion is snap-fitted into the housing portion, the main body may preferentially undergo elastic deformation. This configuration allows the main body to undergo elastic deformation more readily than the housed portion during snap-fitting, facilitating easier snap-fitting.

In the switching apparatus, the movable contact member may include a metallic material with spring properties. Since the movable contact member is made of a metallic material with spring properties, the main body preferentially undergoes elastic deformation during snap-fitting.

In the switching apparatus, the holding member may hold a plurality of the movable contact members juxtaposed in the third direction. The configuration in which the holding member holds the plurality of movable contact members enhances the redundancy of the switching operation.

In the switching apparatus, the switching contact member may include two contact points independent from each other, the first connection state may be a first conduction state in which one of the two contact points and the movable contact member are electrically connected, and the second connection state may be a second conduction state in which another of the two contact points and the movable contact member are electrically connected. This configuration allows for switching between the first conduction state and the second conduction state by switching the contact between the movable contact member and the two contact points.

The switching apparatus may further include a snap-action mechanism. This snap-action mechanism enables instantaneous switching between the first connection state and the second connection state.

In the switching apparatus, the first connection state may be a conduction state in which there is an electrical connection with a contact point provided on the movable contact member, and the second connection state may be a non-conduction state in which there is no electrical connection with the contact point. This configuration allows for switching between the conduction state and the non-conduction state.

### BRIEF DESCRIPTION OF THE DRAWINGS

FIG. 1 is an external perspective view of a switching apparatus according to an embodiment;

FIG. 2 is a side view of the switching apparatus according to an embodiment;

FIG. 3 is a plan view of the switching apparatus according to an embodiment;

FIG. 4 is an exploded perspective view of the switching apparatus according to an embodiment;

FIG. 5 is a perspective view of a holding member and a movable contact member;

FIG. 6 is a perspective view of the holding member and the movable contact member reversed upside down;

FIG. 7 is an exploded perspective view of the holding member and the movable contact member;

FIG. 8 is a diagram illustrating the mounting of the movable contact member on the holding member;

FIG. 9 is a cross-sectional diagram illustrating a state in which the movable contact member is held by the holding member;

FIG. 10A is a schematic diagram illustrating the configuration of snap-fitting;

FIG. 10B is a schematic diagram illustrating the configuration of snap-fitting;

FIG. 11A is a schematic diagram illustrating the configuration of snap-fitting;

FIG. 11B is a schematic diagram illustrating the configuration of snap-fitting;

FIG. 12A is a schematic diagram illustrating the configuration of snap-fitting;

FIG. 12B is a schematic diagram illustrating the configuration of snap-fitting;

FIG. 13A is a schematic diagram illustrating the configuration of snap-fitting;

FIG. 13B is a schematic diagram illustrating the configuration of snap-fitting;

FIG. 13C is a schematic diagram illustrating the configuration of snap-fitting;

FIG. 14A is a schematic diagram illustrating the configuration of snap-fitting;

FIG. 14B is a schematic diagram illustrating the configuration of snap-fitting;

FIG. 15 is a schematic diagram illustrating the operation of the switching apparatus;

FIG. 16 is a schematic diagram illustrating the operation of the switching apparatus;

FIG. 17 is a schematic diagram illustrating the operation of the switching apparatus;

FIG. 18 is a schematic diagram illustrating the operation of the switching apparatus;

FIG. 19 is a schematic diagram illustrating the operation of the switching apparatus;

FIG. 20 is a schematic diagram illustrating the operation of the switching apparatus;

FIG. 21 is a schematic diagram illustrating the operation of the switching apparatus;

FIG. 22 is a schematic diagram illustrating the operation of the switching apparatus;

FIG. 23 is a schematic diagram illustrating the operation of the switching apparatus;

FIG. 24 is a schematic diagram illustrating the operation of the switching apparatus;

FIG. 25 is a schematic diagram illustrating the operation of the switching apparatus; and

FIG. 26 is a schematic diagram illustrating the operation of the switching apparatus.

### DESCRIPTION OF THE PREFERRED EMBODIMENTS

Embodiments of the present invention will be described in detail hereinbelow with reference to the accompanying drawings. In the following description, like components are identified by the same reference signs, and the description of previously explained components will be omitted as appropriate.

### Outline of Switching Apparatus

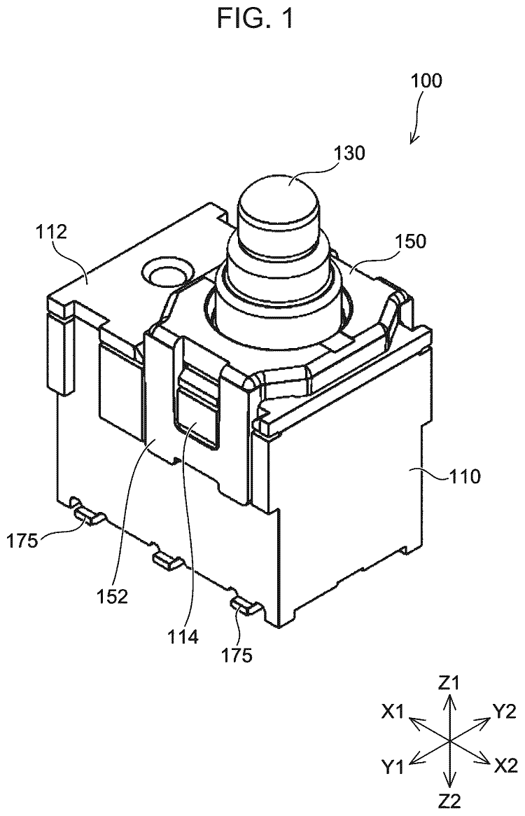

FIG. 1 is an external perspective view of a switching apparatus 100 according to an embodiment.

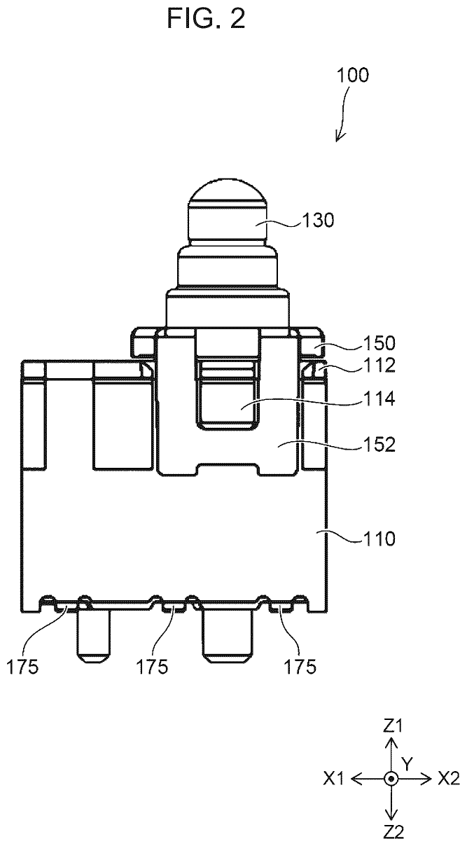

FIG. 2 is a side view of the switching apparatus according 100 to an embodiment.

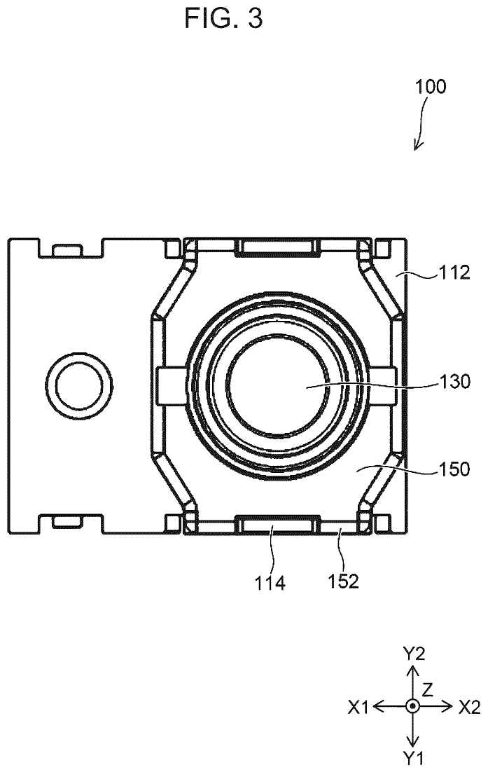

FIG. 3 is a plan view of the switching apparatus 100 according to an embodiment.

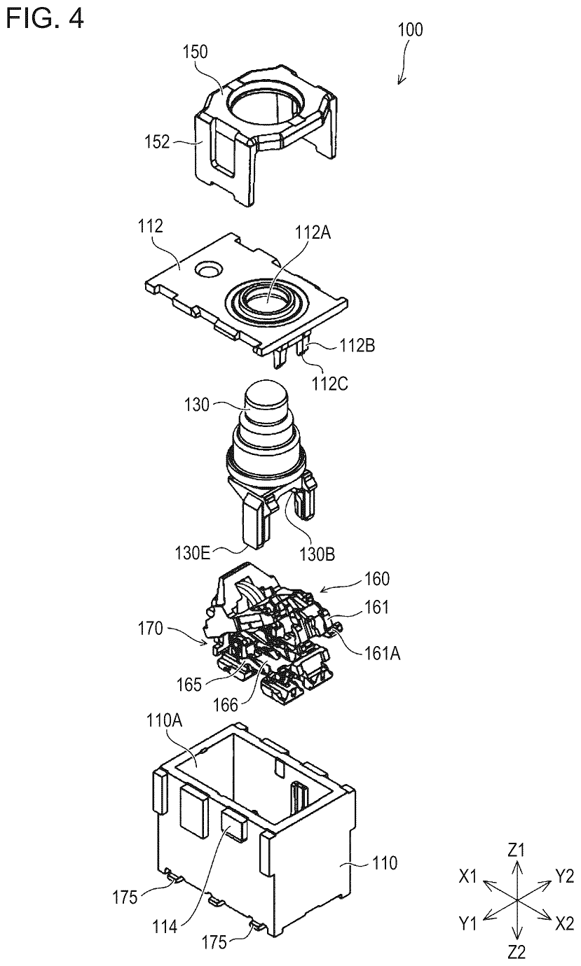

FIG. 4 is an exploded perspective view of the switching apparatus 100 according to an embodiment.

In the following description, the Z1-Z2 direction in the drawings is defined as the Z-axis direction (vertical direction), the X1-X2 direction in the drawings is defined as the X-axis direction (front-back direction), and the Y1-Y2-direction in the drawings is defined as the Y-axis direction (lateral direction) for the sake of convenience. The Z-axis direction is defined as an example of “first direction”, the X-axis direction is defined as an example of “second direction”, and the Y-axis direction is defined as an example of “third direction”.

As illustrated in FIGS. 1 to 3, the switching apparatus 100 includes a case 110, a slider 130, and a holder 150. The case 110 has a hollow structure that is open at the top and has a rectangular parallelepiped shape. The upper opening of the case 110 is blocked by a planar cover 112.

As illustrated in FIG. 4, the cover 112 has a circular opening 112A through which the slider 130 is to be passed. The lower surface of the cover 112 is provided with columnar shafts 112B extending downward. The lower end of each shaft 112B is provided with a first shank 112C that has a downwardly curved, convex-shaped tip. The first shank 112C butts against the upper bearing surface 161A of a first actuator 161 of a movable unit 160 to rotatably support the first actuator 161 from above the first actuator 161.

The slider 130 is a generally cylindrical member designed to receive a pressing operation. The slider 130 passes through the opening 112A of the cover 112 and partially protrudes upward from the upper surface of the cover 112. The slider 130 is slidable on the case 110 in the vertical direction (Z-axis direction).

The switching apparatus 100 can switch the conduction state when the slider 130 is pressed. Specifically, the switching apparatus 100 is in a first connection state when the slider 130 is not pressed. When the switching apparatus 100 is pressed, the slider 130 switches to a second connection state. The first connection state may be a first conduction state, and the second connection state may be a second conduction state. The first connection state may be a conduction state, and the second connection state may be a non-conduction state.

The holder 150 is a ring-shaped member that covers the upper surface of the cover 112 and surrounds the slider 130. The holder 150 includes a pair of hooks 152 extending downward from the outer peripheral edge. The holder 150 is mounted on the case 110 when the pair of hooks 152 are individually engaged with a pair of tabs 114 provided on a pair of parallel sides of the case 110. Thus, the holder 150 fixes the cover 112 to the case 110. For example, the holder 150 is formed by processing a metal plate.

### Configuration of Switching Apparatus

The switching apparatus 100 includes the holder 150, the cover 112, the slider 130, the movable unit 160, and the case 110. In other words, the switching apparatus 100 includes the movable unit 160 illustrated in FIG. 4 in the case 110, in addition to the configuration illustrated in FIGS. 1 to 3.

The case 110 has a space 110A that is open at the top. The space 110A houses a lower part (on the Z2-side) of the slider 130 and the movable unit 160. For example, the case 110 is formed of a relatively hard insulating material (for example, a hard resin) using injection molding.

The movable unit 160 is composed of multiple movable parts. The movable unit 160 operates in conjunction with the vertical movement of the slider 130 caused by a pressing operation, thereby switching the switching apparatus 100 by snap action between the first connection state and the second connection state.

The movable unit 160 includes a switching contact member 170, a movable contact member 165, and a holding member 166.

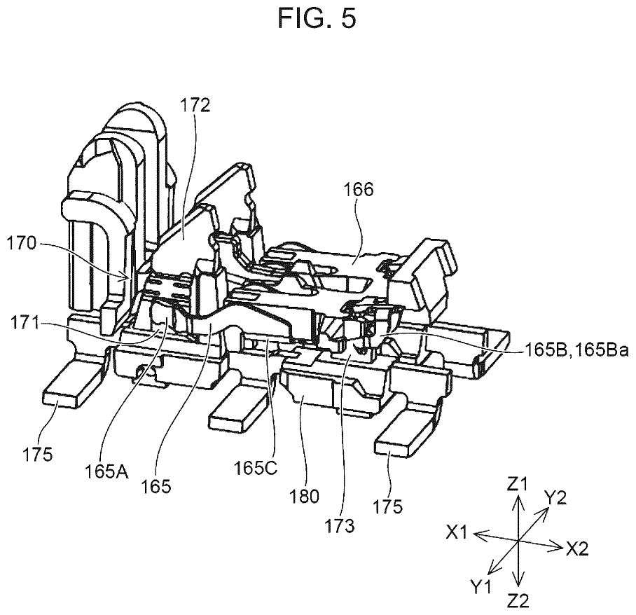

FIG. 5 is a perspective view of the holding member 166 and the movable contact member 165.

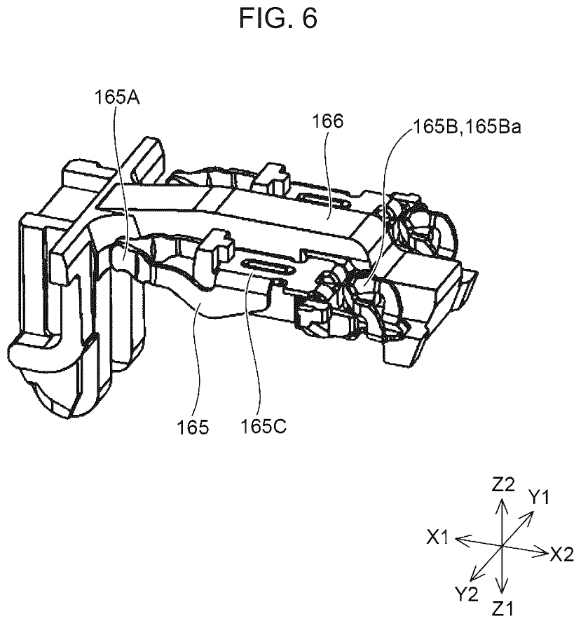

FIG. 6 is a perspective view of the holding member 166 and the movable contact member 165 reversed upside down (rotated 180° about the X-axis).

As illustrated in FIGS. 5 and 6, the movable contact member 165 and the holding member 166 are movable relative to the switching contact member 170. For example, the movable contact member 165 and the holding member 166 are supported by the case 110 so as to fluctuate and are slidable relative to the switching contact member 170 due to vertical movement caused by the pressing operation of the slider 130.

The base member 180 made of an insulating material includes at least two contact points (first contact points 171 and second contact points 172) of the switching contact member 170, a common contact member 173, and terminals 175. Each of the two contact points (the first contact points 171 and the second contact points 172) of the switching contact member 170 and the common contact member 173 is electrically connected to one of the multiple terminals 175. When the movable unit 160 is housed in the space 110A of the case 110, the multiple terminals 175 are exposed from the bottom of the case 110.

The movable contact member 165 is disposed between the switching contact member 170 and the common contact member 173 so as to allow for electrical connection between the switching contact member 170 and the common contact member 173. The two contact points (the first contact points 171 and the second contact points 172) of the switching contact member 170 are disposed away from each other in the Z-axis direction. By moving (for example, sliding) the movable contact member in the Z-axis direction (the first direction) between the two contact points (the first contact points 171 and the second contact points 172), the electrical connection is switched between the common contact member 173 and one of the two contact points (the first contact points 171 and the second contact points 172).

For example, when the movable contact member 165 is in contact with the first contact points 171, the first contact points 171 and the common contact member 173 are electrically connected via the movable contact member 165 into the first connection state. In contrast, when the movable contact member 165 is in contact with the second contact points 172, the second contact points 172 and the common contact member 173 are electrically connected via the movable contact member 165 into the second connection state. The connection state is switched through the up-and-down movement of the slider 130 caused by a pressing operation.

The movable contact member 165 that switches the connection state is held by the holding member 166 made of an insulating material. The holding member 166 is supported by the case 110 so as to fluctuate. The fluctuation causes the connection position of the movable contact member 165 relative to the switching contact member 170 to be switched.

The movable contact member 165 includes a main body 165C extending along the X-axis direction (the second direction), a pair of contact pieces 165A, and a common contact portion 165B. The pair of contact pieces 165A are provided at one end (on the X1 side in the X1-X2 direction) of the main body 165C, extends along the X-axis direction, and are juxtaposed in the Y-axis direction (the third direction) so as to clamp the switching contact member 170. The common contact portion 165B comes into contact with the common contact member 173 and is disposed at a portion of the main body 165C different from the portion at which the pair of contact pieces 165A is disposed (for example, the other end (on the X2 side in the X1-X2 direction) of the main body 165C. The common contact portion 165B may include a pair of clamping pieces 165Ba. The pair of clamping pieces 165Ba of the common contact portion 165B are juxtaposed in the Y-axis direction so as to clamp the common contact member 173.

The movable contact member 165 is formed, for example, by pressing a metallic material with spring properties. The movable contact member 165 is configured as a separate component from the holding member 166 made of an insulating material and is combined with the holding member 166. Multiple movable contact members 165 may be attached to one holding member 166.

In this embodiment, two movable contact members 165 are juxtaposed in Y-axis direction on the holding member 166. Two switching contact members 170, two common contact members 173, and two terminals 175 are provided for each of the movable contact members 165. By providing two movable contact members 165 and so on for one holding member 166, the redundancy of the switching operation is enhanced. The number of movable contact members 165 and so on provided for one holding member 166 is not limited to two and may be one or three or more.

### Holding Member and Movable Contact Member

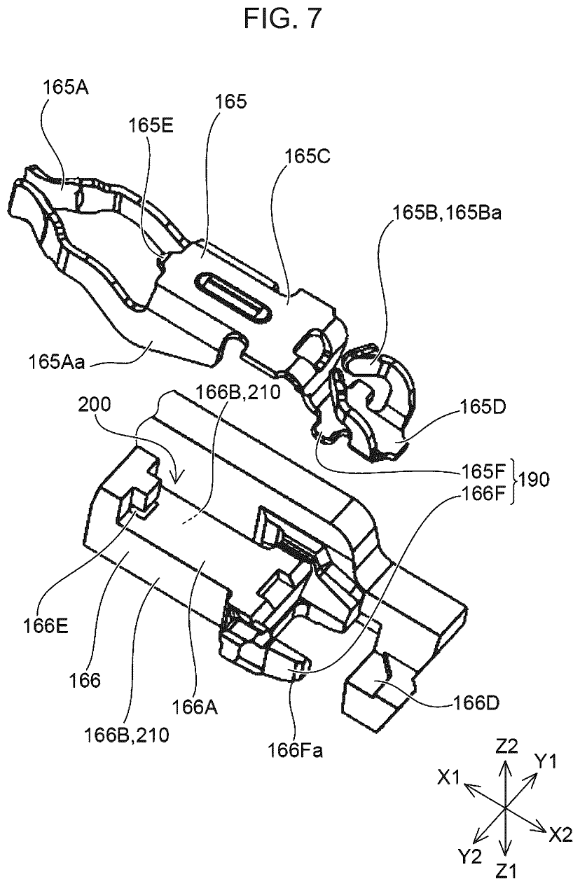

FIG. 7 is an exploded perspective view of the holding member 166 and the movable contact member 165.

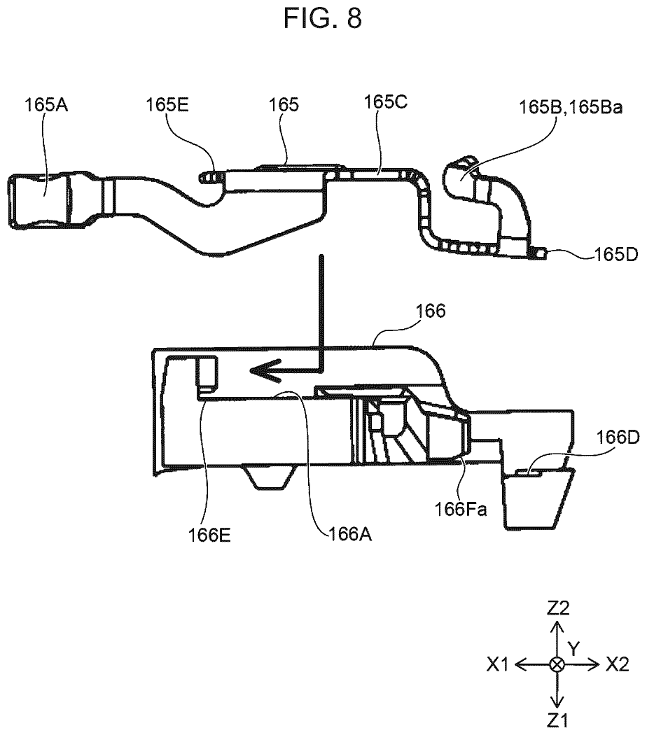

FIG. 8 is a diagram illustrating the mounting of the movable contact member 165 on the holding member 166.

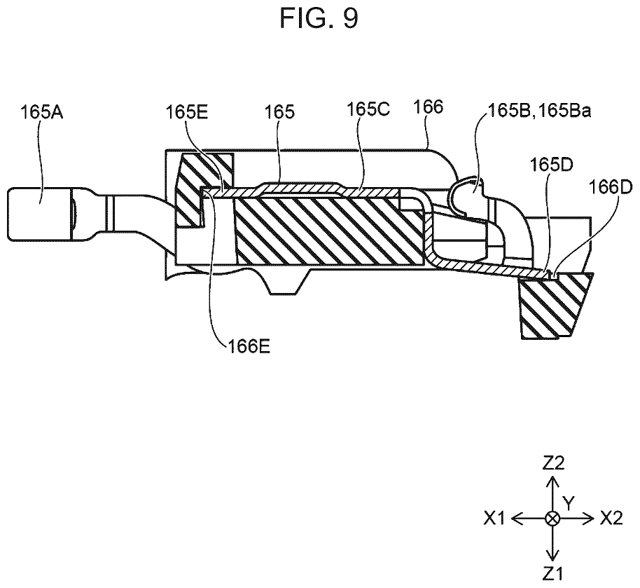

FIG. 9 is a cross-sectional diagram illustrating a state in which the movable contact member 165 is held by the holding member 166.

FIGS. 7 to 9 illustrate the relationship between the holding member 166 and one movable contact member 165 for the sake of convenience.

The holding member 166 includes a housing portion 166D configured to house a housed portion 165D of the main body 165C of the movable contact member 165. In this embodiment, for example, the main body 165C is provided with the protruding housed portion 165D protruding in the second direction (on the X2 side in the X1-X2 direction) at the end on the common contact portion 165B side, and the holding member 166 is provided with a recessed housing portion 166D configured to house the housed portion 165D. The housed portion 165D of the main body 165C is designed to be snap-fitted into the housing portion 166D of the holding member 166. As illustrated in FIGS. 7 to 9, the housing portion 166D is recessed to the Z1 side in the Z1-Z2 direction from the periphery (specifically, the portion on the X2 side in the X1-X2 direction). For this reason, when the movable contact member 165 moves to the X1 side in the X1-X2 direction, the housed portion 165D moves so as to enter the recess, that is, to the Z1 side in the Z1-Z2 direction, and is housed in the housing portion 166D. This causes the holding member 166 to restrict the displacement of the main body 165C in the X-axis direction while allowing for a predetermined displacement in the Y-axis direction. Specifically, when the main body 165C is displaced to the X2 side in the X1-X2 direction, the housed portion 165D comes into contact with the level-difference of the housing portion 166D on the X2 side in the X1-X2 direction, thereby restricting the further displacement of the main body 165C to the X2 side in the X1-X2 direction.

The holding member 166 may further include a slit 166E that restricts the displacement of the main body 165C in the moving direction of the housed portion 165D when the housed portion 165D is housed in the housing portion 166D. A portion of the main body 165C different from the housed portion 165D may be provided with an insertion portion 165E. The insertion portion 165E is inserted into the slit 166E.

The gap in the Z-axis direction of the slit 166E is provided substantially the same as the thickness of the insertion portion 165E. This allows, when the insertion portion 165E moves to the X1 side in the X1-X2 direction into the slit 166E, as illustrated in FIG. 8, the displacement in the Z-axis direction of the main body 165C integrally connected to the insertion portion 165E to be restricted. Furthermore, since the slit 166E is closed on the X1 side in the X1-X2 direction, further displacement of the main body 165C to the X1 side in the X1-X2 direction is restricted because the insertion portion 165E further comes into contact with the slit 166E. Furthermore, when the housed portion 165D integrally connected to the main body 165C is snap-fitted into the housing portion 166D, with the insertion portion 165E inserted in the slit 166E, the displacement of the main body 165C to the X2 side in the X1-X2 direction is restricted, as described above. Thus, the displacement of the main body 165C relative to the holding member 166 in the Z-axis direction and the X-axis direction is restricted.

To snap-fit the movable contact member 165 into the holding member 166, the main body 165C of the movable contact member 165 is placed on a mount surface 166A of the holding member 166, with the holding member 166 reversed upside down, as illustrated in FIGS. 7 and 8, and the main body 165C is slid forward (to the X1 side in the X1-X2 direction) (see the arrow in FIG. 8). Thus, the insertion portion 165E provided at the main body 165C is inserted into the slit 166E.

The housed portion 165D of the main body 165C is press-fitted into the housing portion 166D of the holding member 166, with the insertion portion 165E inserted in the slit 166E. Since the movable contact member 165 is made of a metallic material with spring properties, the main body 165C preferentially undergoes elastic deformation to cause the housed portion 165D to be fitted into the housing portion 166D. Thus, the movable contact member 165 is snap-fitted into the holding member 166.

In this embodiment, in snap-fitting, the direction in which the main body 165C is moved relative to the holding member 166 (the X-axis direction) for snap-fitting and the moving direction of the housed portion 165D when housed into the housing portion 166D by snap-fitting (the Z-axis direction) cross at right angles. Therefore, the Y-axis direction is not concerned with the series of movement for the snap-fitting. For this reason, even in snap-fitting, the main body 165C may be displaced in the Y-axis direction relative to the holding member 166.

The movable contact member 165 is in elastic-contact with the switching contact member 170 and the common contact member 173 so as to clamp them in the Y-axis direction. In other words, the pair of contact pieces 165A of the movable contact member 165 is in elastic-contact with the contact points (the first contact points 171 and the second contact points 172) of the switching contact member 170 so as to clamp the contact points, and the pair of clamping pieces 165Ba of the movable contact member 165 is in elastic-contact with the common contact member 173 so as to clamp the common contact member 173. For this reason, if displacement occurs in the relative position in the Y-axis direction between the movable contact member 165 and the switching contact member 170 and the common contact member 173, the stress balance between the pair of pieces (the pair of contact pieces 165A and the pair of clamping pieces 165Ba) of the movable contact member 165 at elastic contact is disrupted.

Even if displacement occurs in the relative position in the Y-axis direction between the movable contact member 165, and the switching contact member 170 and the common contact member 173, the configuration of this embodiment in which the holding member 166 holds the movable contact member 165 while allowing the displacement in the Y-axis direction of the main body 165C of the movable contact member 165 allows the movable contact member 165 to move in the Y-axis direction to self-align with the positions of the switching contact member 170 and the common contact member 173, thereby suppressing the disruption of stress balance between the pair of pieces.

Furthermore, the movable contact member 165 and the holding member 166, even if configured as separate components rather than being integrally formed by methods such as insert molding, can still be assembled by snap-fitting. For this reason, even such separate components can be easily manufactured.

In this snap-fitting, an urging structure 190 may be provided which urges the housed portion 165D into elastic contact with the housing portion 166D, with the housed portion 165D snap-fitted in the housing portion 166D. In this embodiment, in a specific example, the urging structure 190 may include a protrusion 166F provided at the holding member 166 and an engaging piece 165F provided at the main body 165C and integrally connected to the housed portion 165D. The protrusion 166F may have an inclined surface 166Fa. The engaging piece 165F slides on the inclined surface 166Fa as the housed portion 165D moves when the housed portion 165D is snap-fitted in the housing portion 166D, thereby increasing the degree of elastic deformation of the engaging piece 165F.

Specifically, when the main body 165C is slid in the X-axis direction (to the X1 side in the X1-X2 direction), with the insertion portion 165E inserted in the slit 166E, the engaging piece 165F extending in the Y-axis direction from the main body 165C gets under the protrusion 166F (with the holding member 166 reversed upside down) and slides along the inclined surface 166Fa to gradually push down the engaging piece 165F as the main body 165C is slid forward (to the X1 side in the X1-X2 direction). This increases the degree of elastic deformation of the engaging piece 165F, thereby urging the housed portion 165D of the main body 165C in the Z-axis direction (to the Z1 side in the Z1-Z2 direction). Finally, the housed portion 165D is snap-fitted into the housing portion 166D, thereby maintaining the elastic-contact between the housed portion 165D and the housing portion 166D.

When the housed portion 165D and the housing portion 166D are elastically connected in this manner, a force greater than the frictional force due to the elastic-contact is required to displace the housed portion 165D in the housing portion 166D. For this reason, the main body 165C is not displaced relative to the holding member 166 even under some vibrations, preventing lack of contact stability due to vibrations.

The housed portion 165D and the housing portion 166D may be elastically connected along the Z-axis direction. Since the urging direction of the urging structure 190 is along the Z-axis direction, the influence of the sliding resistance at the switching operation (fluctuations of the movable contact member 165 due to the force in the direction in which the movable contact member 165 separates from the holding member 166) is reduced or eliminated.

The holding member 166 may include a restricting portion 200 that restricts the range of displacement in the Y-axis direction relative to the holding member 166 of the movable contact member 165. The restricting portion 200 may include an intercalated portion 210 positioned in the gap in the Y-axis direction between the pair of contact pieces 165A. Examples of the intercalated portion 210 include side surfaces 166B provided on the opposite sides in the Y-axis direction of the mount surface 166A of the main body 165C (surfaces perpendicular to the mount surface 166A). Between the pair of contact pieces 165A and the main body 165C of the movable contact member 165, bent portions 165Aa are provided which are bent from the opposite sides in the Y-axis direction of the main body 165C in the Z-axis direction (to the Z1 side in the Z1-Z2 direction).

The bent portions 165Aa are disposed so as to cover the outside of the side surfaces 166B of the holding member 166 when the movable contact member 165 is snap-fitted in the holding member 166. A gap in the Y-axis direction is provided between each bent portion 165Aa and each side surface 166B. The bent portions 165Aa and the side surfaces 166B constitute the restricting portion 200. The movement in the Y-axis direction of the movable contact member 165 relative to the holding member 166 is restricted by the amount of the gap in the Y-axis direction between the bent portion 165Aa and the side surface 166B. Another example of the specific structure of the restricting portion 200 is a structure in which one of the main body 165C and the holding member 166 has a recess, and a protrusion provided on the other is loosely fitted in the recess.

### Configuration of Snap-Fitting

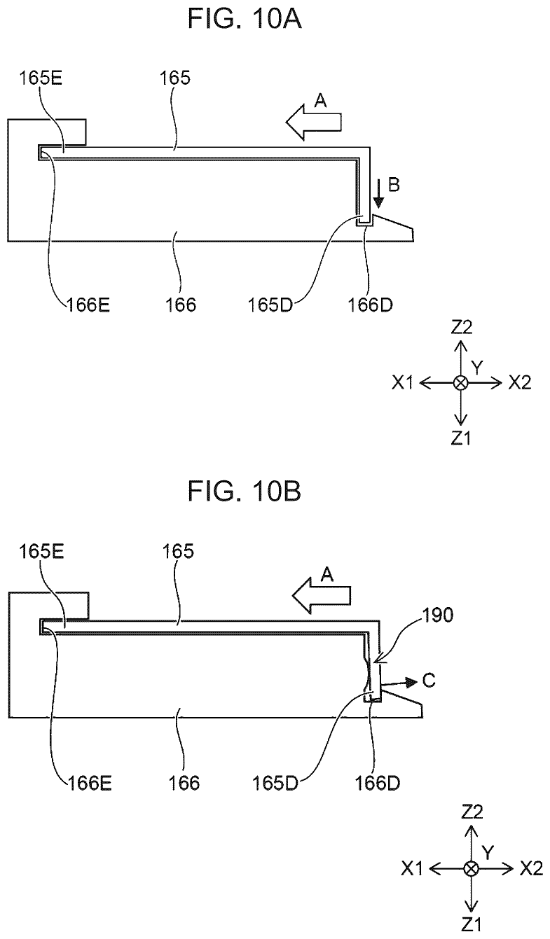

FIGS. 10A to 14B are schematic diagrams illustrating the configuration of snap-fitting.

In the configuration of snap-fitting illustrated in FIG. 10A, when snap-fitting the movable contact member 165 into the holding member 166, the movable contact member 165 is moved in the X-axis direction indicated by arrow A (to the X1 side in the X1-X2 direction) to insert the insertion portion 165E into the slit 166E, and the housed portion 165D is housed in the housing portion 166D, thereby achieving snap-fitting. In the snap-fitting, the housed portion 165D is moved in the Z-axis direction indicated by arrow B (to the Z1 side in the Z1-Z2 direction), thereby being housed in the housing portion 166D. In other words, when the movable contact member 165 moves to the X1 side in the X1-X2 direction indicated by arrow A, the portion of the holding member 166 protruding in the X2 side in the X1-X2 direction from the housing portion 166D comes into contact with the end of the housed portion 165D. This contact causes at least one of the elastic deformation of the protruding portion of the holding member 166 to incline to the Z1 side in the Z1-Z2 direction and the elastic deformation of part of the movable contact member 165 to move the end of the housed portion 165D to the Z2 side in the Z1-Z2 direction. When the movable contact member 165 moves to the X1 side in the X1-X2 direction in this state, the housed portion 165D moves into the housing portion 166D, thereby releasing the above elastic deformation and suppressing displacement of the housed portion 165D toward the X2 side in the X1-X2 direction.

Thus, with the configuration of snap-fitting illustrated in FIG. 10A, since the moving direction of the housed portion 165D when snap-fitted into the housing portion 166D is the Z-axis direction, the movement of the movable contact member 165 in the X-axis direction is restricted by snap-fitting. Furthermore, the moving direction of the insertion portion 165E when inserted into the slit 166E is the X-axis direction. Therefore, in the state in which the insertion portion 165E is inserted into the slit 166E, the movement of the movable contact member 165 in the Z-axis direction is restricted.

In the configuration of snap-fitting illustrated in FIG. 10B, the urging structure 190 that urges the housed portion 165D into elastic-contact with the housing portion 166D is provided in addition to the configuration illustrated in FIG. 10A. In other words, when the movable contact member 165 is to be snap-fitted into the holding member 166, the movable contact member 165 is moved in the X-axis direction indicated by arrow A (to the X1 side in the X1-X2 direction) to insert the insertion portion 165E into the slit 166E, and the housed portion 165D is housed into the housing portion 166D, thereby achieving snap-fitting.

In the snap-fitted state, the urging structure 190 urges the housed portion 165D in the X-axis direction indicated by arrow C (to the X2 side in the X1-X2 direction) to bring the housed portion 165D into elastic-contact with the housing portion 166D. This restricts the movement of the movable contact member 165 in the Z-axis direction and the X-axis direction, as with the configuration illustrated in FIG. 10A, and the elastic-contact between the housed portion 165D and the housing portion 166D using the urging structure 190 enhances the stability in holding the movable contact member 165 with the holding member 166.

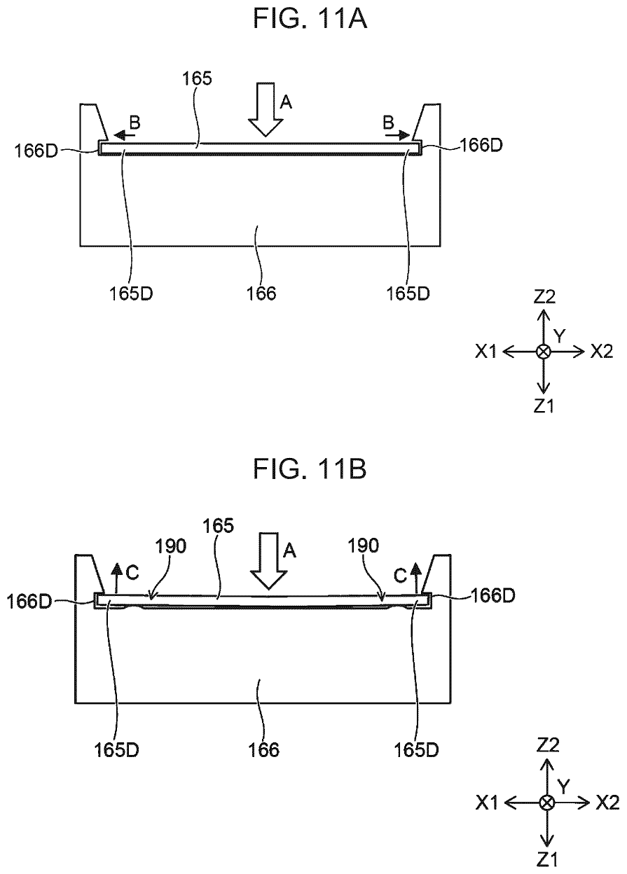

With the configuration of snap-fitting illustrated in FIG. 11A, the holding member 166 includes multiple housing portions 166D, and the movable contact member 165 includes multiple housed portions 165D. This configuration allows the individual multiple housed portions 165D are snap-fitted in the corresponding housing portions 166D.

When snap-fitting the movable contact member 165 into the holding member 166, the movable contact member 165 is moved in the Z-axis direction indicated by arrow A (to the Z1 side in the Z1-Z2 direction) to house the individual housed portions 165D in the corresponding housing portions 166D, thereby achieving snap-fitting. In the snap-fitting, the housed portions 165D are moved in the X-axis direction indicated by arrow B, thereby being housed in the housing portions 166D. In the snap-fitted state, the movable contact member 165 is restricted in the X-axis direction and also in the Z-axis direction by the multiple housing portions 166D.

In the configuration of snap-fitting illustrated in FIG. 11B, the urging structure 190 that urges the housed portions 165D into elastic-contact with the housing portions 166D is provided in addition to the configuration illustrated in FIG. 11A. In other words, when the movable contact member 165 is to be snap-fitted into the holding member 166, the movable contact member 165 is moved in the Z-axis direction indicated by arrow A (to the Z1 side in the Z1-Z2 direction) to house the individual housed portions 165D into the corresponding housing portions 166D, thereby achieving snap-fitting.

In the snap-fitted state, the urging structure 190 urges the housed portions 165D in the Z-axis direction indicated by arrow C (to the Z2 side in the Z1-Z2 direction) to bring the housed portions 165D into elastic-contact with the housing portions 166D. This restricts the movement of the movable contact member 165 in the Z-axis direction and the X-axis direction, as with the configuration illustrated in FIG. 11A, and the elastic-contact between the housed portions 165D and the housing portions 166D using the urging structure 190 enhances the stability in holding the movable contact member 165 with the holding member 166.

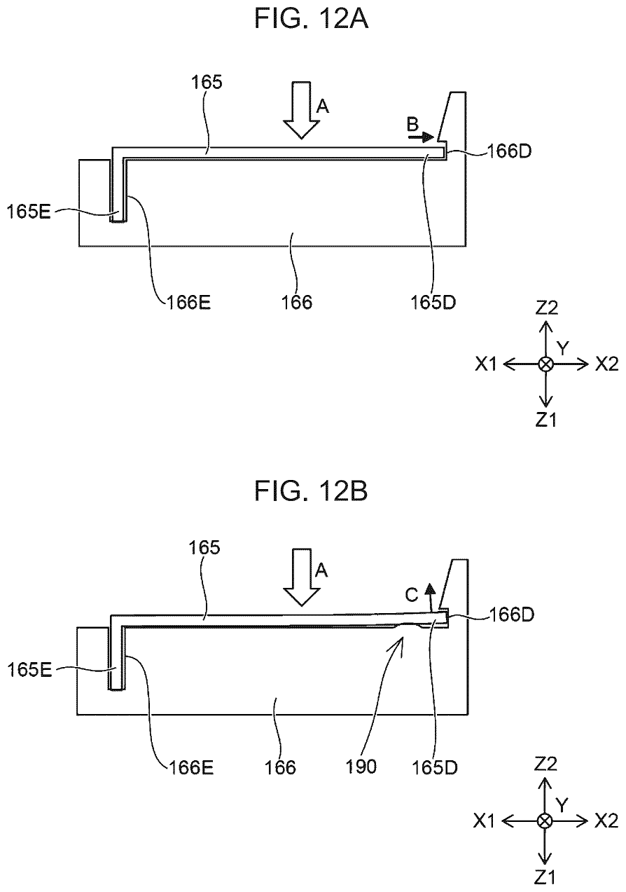

In the configuration of snap-fitting illustrated in FIG. 12A, when snap-fitting the movable contact member 165 into the holding member 166, the movable contact member 165 is moved in the Z-axis direction indicated by arrow A (to the Z1 side in the Z1-Z2 direction) to insert the insertion portion 165E into the slit 166E, and the housed portion 165D is housed in the housing portion 166D, thereby achieving snap-fitting. In the snap-fitting, the housed portion 165D is moved in the X-axis direction indicated by arrow B (to the X2 side in the X1-X2 direction), thereby being housed in the housing portion 166D.

Since the moving direction of the housed portion 165D when snap-fitted into the housing portion 166D is the Z-axis direction, the movement of the movable contact member 165 in the X-axis direction is restricted by snap-fitting. Furthermore, the moving direction of the insertion portion 165E when inserted into the slit 166E is the Z-axis direction. Therefore, in the state in which the insertion portion 165E is inserted into the slit 166E, the movement of the movable contact member 165 in the X-axis direction is restricted.

In the configuration of snap-fitting illustrated in FIG. 12B, the urging structure 190 that urges the housed portion 165D into elastic-contact with the housing portion 166D is provided in addition to the configuration illustrated in FIG. 12A. In other words, when the movable contact member 165 is to be snap-fitted into the holding member 166, the movable contact member 165 is moved in the Z-axis direction indicated by arrow A (to the Z1 side in the Z1-Z2 direction) to insert the insertion portion 165E into the slit 166E, and the housed portion 165D is housed into the housing portion 166D, thereby achieving snap-fitting.

In the snap-fitted state, the urging structure 190 urges the housed portion 165D in the Z-axis direction indicated by arrow C (to the Z2 side in the Z1-Z2 direction) to bring the housed portion 165D into elastic-contact with the housing portion 166D. This restricts the movement of the movable contact member 165 in the Z-axis direction and the X-axis direction, as with the configuration illustrated in FIG. 12A, and the elastic-contact between the housed portion 165D and the housing portion 166D using the urging structure 190 enhances the stability in holding the movable contact member 165 with the holding member 166.

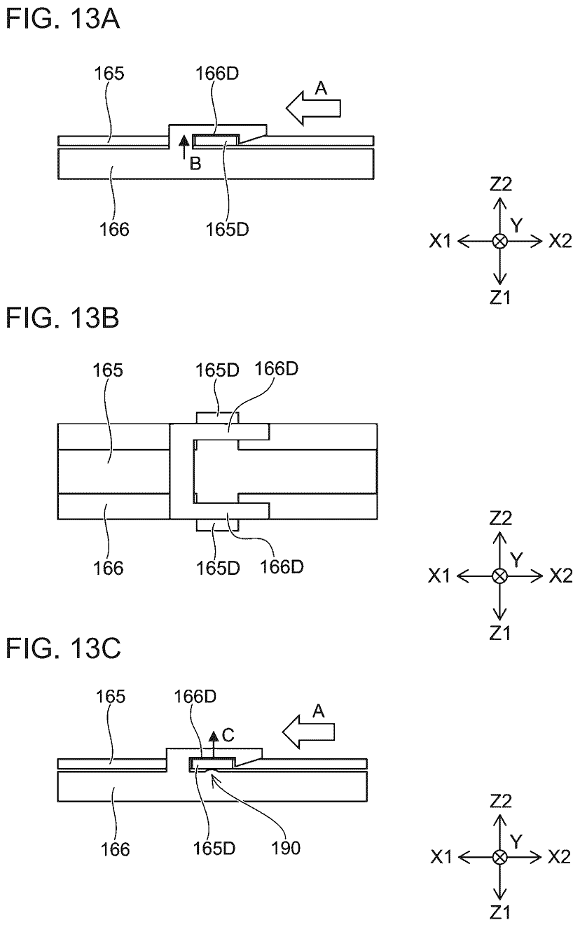

In the configuration of snap-fitting illustrated in FIGS. 13A and 13B (FIG. 13B is a plan view) of FIG. 13A), two housed portions 165D extending in the Y-axis direction from opposite sides of the movable contact member 165 are provided substantially at the center of movable contact member 165, and two housing portions 166D corresponding to the two housed portions 165D are provided substantially at the center of the holding member 166. When the movable contact member 165 is to be snap-fitted into the holding member 166, the movable contact member 165 is moved in the X-axis direction indicated by arrow A (to the X1 side in the X1-X2 direction) to house the two housed portions 165D into the corresponding housing portions 166D, thereby achieving snap-fitting. In the snap-fitting, the two housed portions 165D are moved in the Z-axis direction indicated by arrow B (to the Z2 side in the Z1-Z2 direction) and housed into the corresponding housing portions 166D.

Since the moving direction of the two housed portions 165D when snap-fitted into the housing portions 166D is the Z-axis direction, the movement of the movable contact member 165 in the X-axis direction is restricted by snap-fitting. Furthermore, the moving direction of the movable contact member 165 when the two housed portions 165D are snap-fitted into the housing portions 166D is the X-axis direction. Therefore, in the snap-fitted state, the movement of the movable contact member 165 in the Z-axis direction is restricted.

In the configuration of snap-fitting illustrated in FIG. 13C, the urging structure 190 that urges the housed portions 165D into elastic-contact with the housing portions 166D is provided in addition to the configuration illustrated in

FIGS. 13A and 13B. In other words, when the movable contact member 165 is to be snap-fitted into the holding member 166, the movable contact member 165 is moved in the X-axis direction indicated by arrow A (to the X1 side in the X1-X2 direction) to house the two housed portions 165D into the corresponding housing portions 166D, thereby achieving snap-fitting.

In the snap-fitted state, the urging structure 190 urges the housed portions 165D in the Z-axis direction indicated by arrow C (to the Z2 side in the Z1-Z2 direction) to bring the housed portions 165D into elastic-contact with the housing portions 166D. This restricts the movement of the movable contact member 165 in the Z-axis direction and the X-axis direction, as with the configuration illustrated in FIGS. 13A and 13B, and the elastic-contact between the housed portions 165D and the housing portions 166D using the urging structure 190 enhances the stability in holding the movable contact member 165 with the holding member 166.

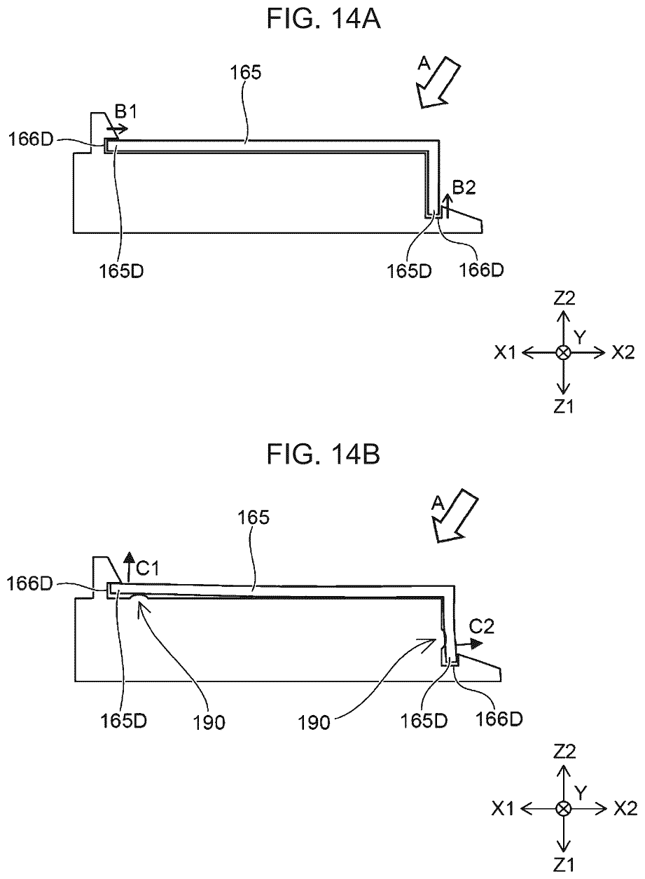

In the configuration of snap-fitting illustrated in FIG. 14A, the holding member 166 is provided with two housing portions 166D, and the movable contact member 165 is provided with two housed portions 165D corresponding thereto. One of the housing portions 166D is provided at the front top of the holding member 166, and the other of the housing portions 166D is provided at the back side of the holding member 166. This configuration allows the two housed portions 165D to be snap-fitted in the corresponding housing portions 166D.

When snap-fitting the movable contact member 165 into the holding member 166, the movable contact member 165 is moved in the direction indicated by arrow A (diagonally forward and downward) to house the two housed portions 165D in the corresponding housing portions 166D, thereby achieving snap-fitting. In the snap-fitting, one of the housed portions 165D is moved in the X-axis direction indicated by arrow B1 (to the X2 side in the X1-X2 direction), thereby being housed in the housing portion 166D, and the other of the housed portions 165D is moved in the Z-axis direction indicated by arrow B2 (to the Z2 side in the Z1-Z2 direction), thereby being housed in the housing portion 166D. In the snap-fitted state, the movable contact member 165 is restricted in the Z-axis direction and in the X-axis direction by the two housing portions 166D.

In the configuration of snap-fitting illustrated in FIG. 14B, the urging structures 190 that urge the housed portions 165D into elastic-contact with the housing portions 166D are provided in addition to the configuration illustrated in FIG. 14A. In other words, when the movable contact member 165 is to be snap-fitted into the holding member 166, the movable contact member 165 is moved in the direction indicated by arrow A (diagonally forward and downward) to house the two housed portions 165D into the corresponding housing portions 166D, thereby achieving snap-fitting.

In the snap-fitted state, the urging structures 190 urge one of the housed portions 165D in the Z-axis direction indicated by arrow C1 (to the Z2 side in the Z1-Z2 direction), and the other of the housed portions 165D in the X-axis direction indicated by arrow C2 (to the X2 side in the X1-X2 direction) to bring the housed portions 165D into elastic-contact with the housing portions 166D individually. This restricts the movement of the movable contact member 165 in the Z-axis direction and the X-axis direction, as with the configuration illustrated in FIG. 14A, and the elastic-contact between the housed portions 165D and the housing portions 166D using the urging structures 190 enhances the stability in holding the movable contact member 165 with the holding member 166.

In any configurations in FIGS. 10A to 14B, the movable contact member 165 is held by the holding member 166 via snap-fitting, and at least one of displacement of the movable contact member 165 in the Z-axis direction and displacement in the X-axis direction can be restricted while allowing a predetermined displacement in the Y-axis direction.

### Operation of Switching Apparatus

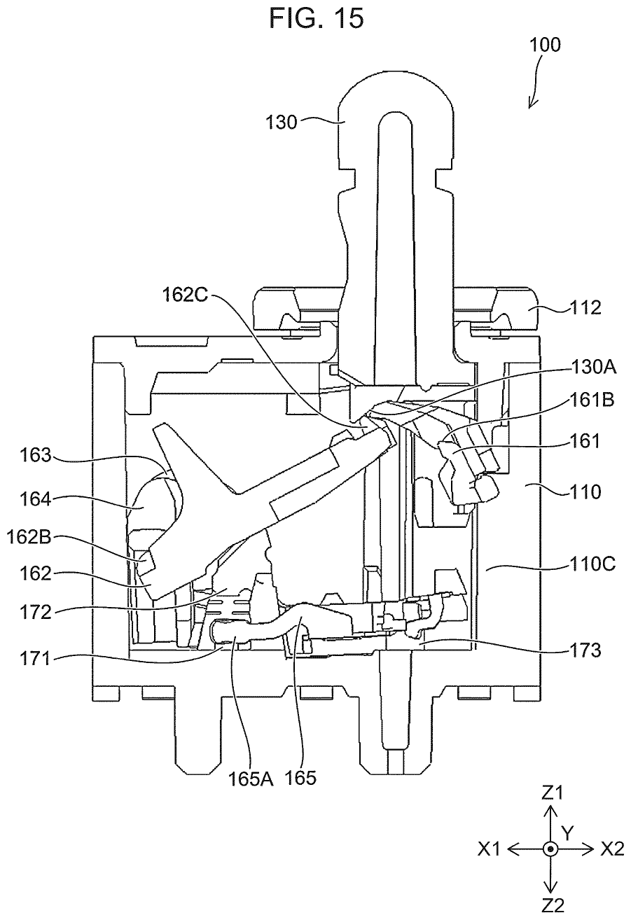

FIGS. 15 to 26 are schematic diagrams illustrating the operation of the switching apparatus.

### First State

FIG. 15 illustrates a state in which the slider 130 is not pressed (a first state). In the first state, a pressing surface 130A provided at the lower end of the slider 130 is in contact with a cam lobe 162C provided at an end of a cam 162. In the first state, the movable contact member 165 held by a second actuator 164 is in a horizontal state, the pair of contact pieces 165A is in contact with the first contact points 171, and the common contact portion 165B is in contact with the common contact member 173. In other words, the switching apparatus 100 is in the first connection state.

### Second State

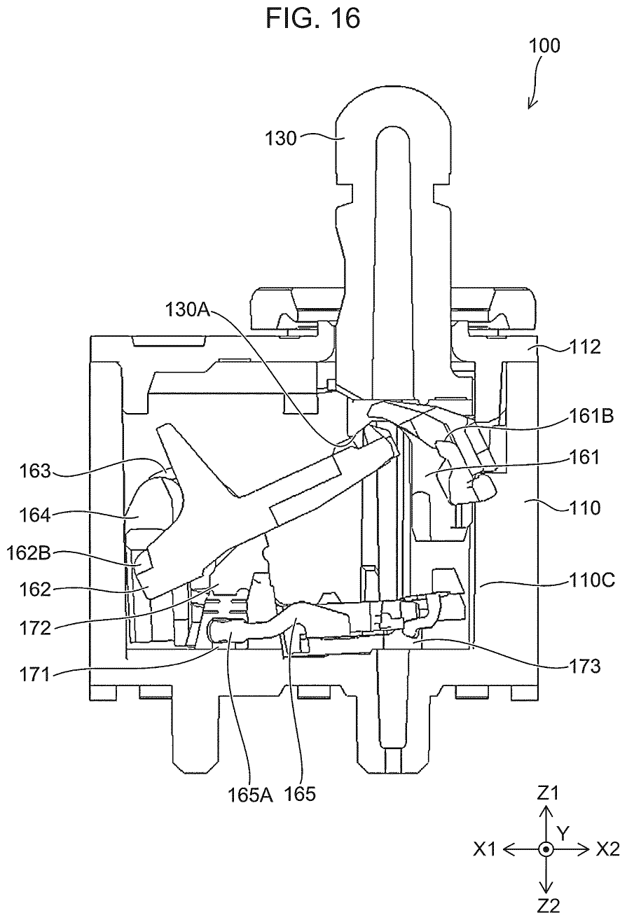

When the pressing operation of the slider 130 is started from the first state illustrated in FIG. 15, the pressing surface 130A of the slider 130 pushes the cam lobe 162C of the cam 162 downward, as illustrated in FIG. 16. This causes the cam 162 to start to rotate downward about a rotary shaft 162B journaled by a shaft 164A of the second actuator 164.

As illustrated in FIG. 16, when the slider 130 starts to slide downward, thereby slightly sliding downward, pressing portions 130B (see FIG. 4) at the opposite sides in the lateral direction (Y-axis direction) of the slider 130 come into contact with upper contact surfaces 161B at the opposite sides in the lateral direction (Y-axis direction) of the first actuator 161. This causes the slider 130 to start to push down the first actuator 161, in addition to pushing down the cam 162. Since the first actuator 161 is pushed down by the pressing portions 130B of the slider 130, the first actuator 161 starts to rotate downward about the first shanks 112C (see FIG. 4).

### Third State

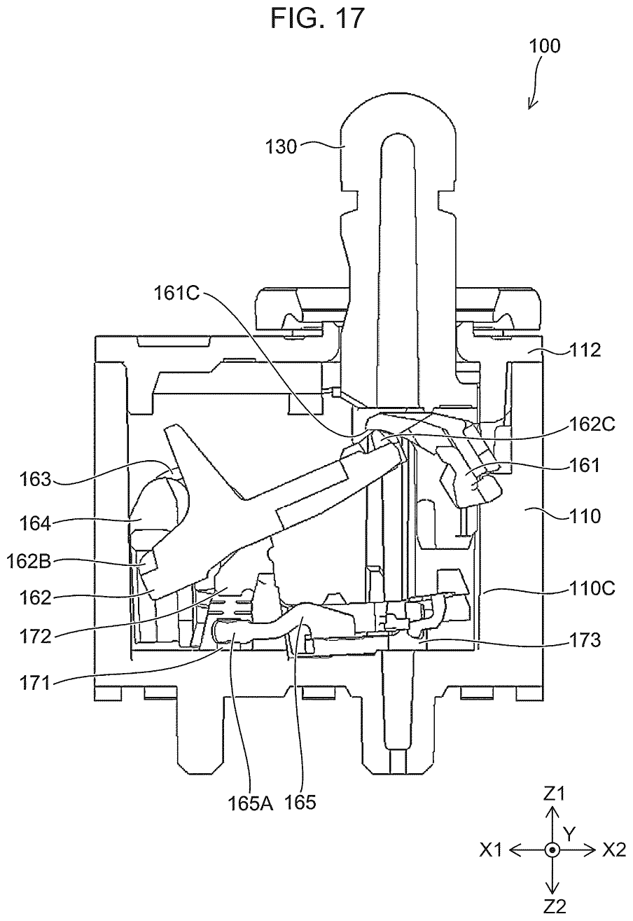

When the slider 130 further slightly slides downward from the second state illustrated in FIG. 16, a lower inclined surface 161C of the first actuator 161 comes into contact with the cam lobe 162C of the cam 162, as illustrated in FIG. 17. Thereafter, the cam lobe 162C of the cam 162 is separated from the pressing surface 130A of the slider 130 and is pushed down by the lower inclined surface 161C of the first actuator 161.

### Fourth State

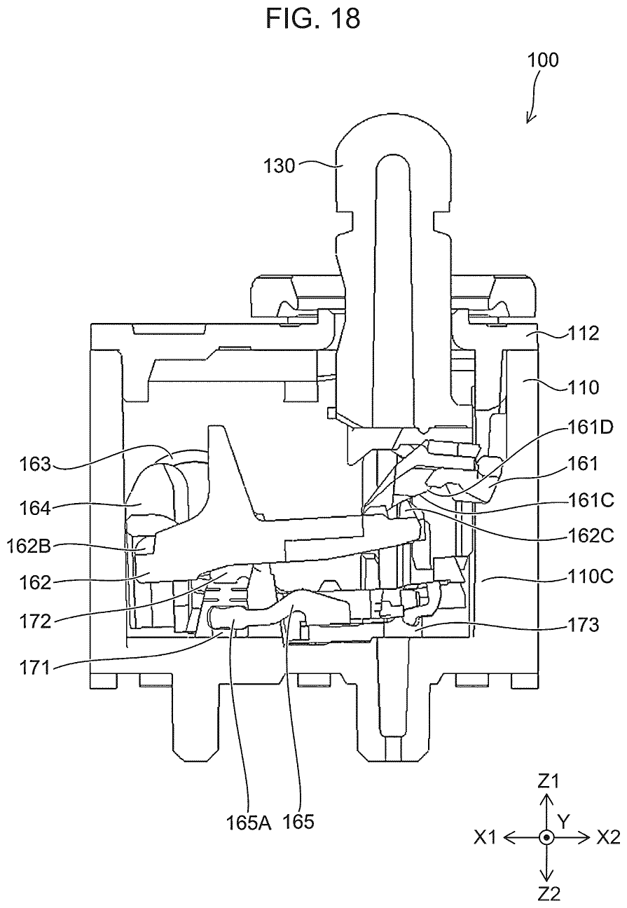

As illustrated in FIG. 18, when the first actuator 161 rotates downward to a predetermined angle, the rotation of the first actuator 161 is restricted. At this time, the force of the cam lobe 162C of the cam 162 moving to slide up the lower inclined surface 161C of the first actuator 161 due to the urging force from a torsion spring 163 exceeds the frictional resistance between the cam lobe 162C and the lower inclined surface 161C. This causes the cam lobe 162C to instantly slide up over the lower inclined surface 161C toward the top 161D of the lower inclined surface 161C to reach the top 161D and stops. On this occasion, since the top 161D has a gentle curved surface, the contact sound between the cam lobe 162C and the top 161D is suppressed. Fifth State

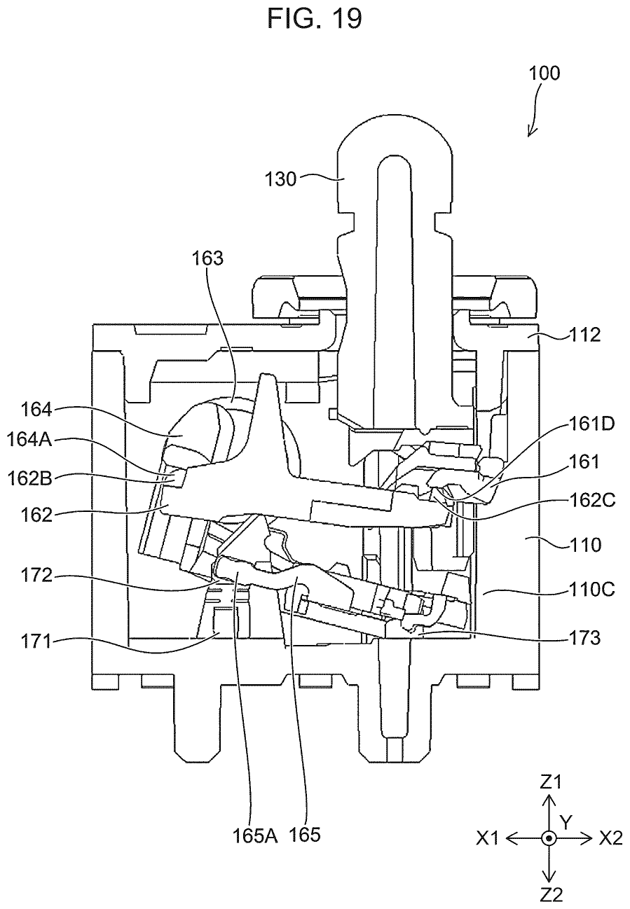

This causes the rotary shaft 162B of the cam 162 to instantly move up the shaft 164A of the second actuator 164, as illustrated in FIG. 19. At this time, the second actuator 164 rotates upward about the contact point (that is, the bent portion of the common contact member 173) between the common contact portion 165B of the movable contact member 165 held by the second actuator 164 and the common contact member 173. This causes the contact positions of the pair of contact pieces 165A of the movable contact member 165 held by the second actuator 164 to be instantly switched from the first contact points 171 to the second contact points 172. As a result, the second contact points 172 and the common contact member 173 are electrically connected via the movable contact member 165, in other words, the switching apparatus 100 is switched to the second connection state. Thus, the switching apparatus 100 is capable of instant switching operation using a snap action.

### Sixth State

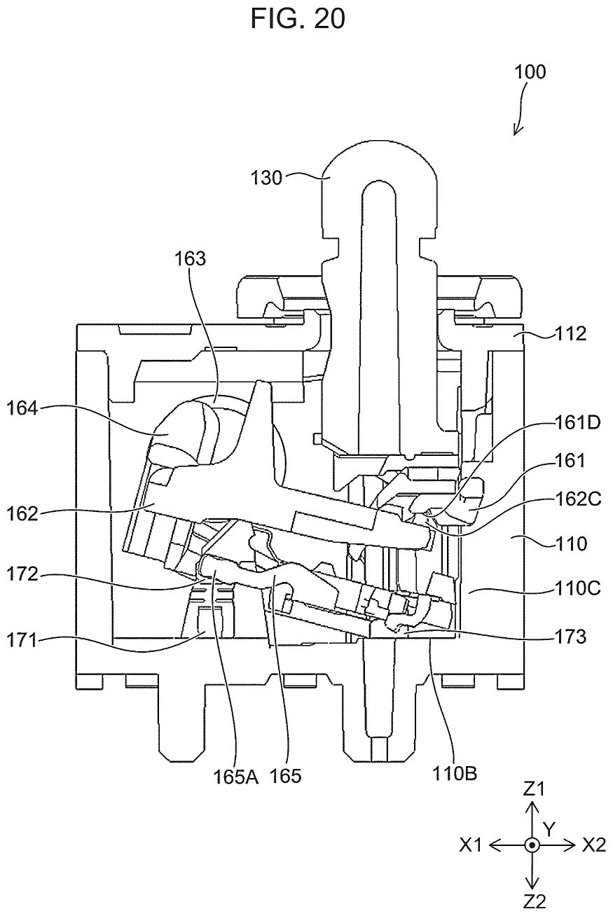

As illustrated in FIG. 20, when the slider 130 is further pushed down by overstroke in which the slider 130 is further pushed down after the switching operation, the first actuator 161 slides downward together with the slider 130 while pushing down the cam lobe 162C of the cam 162, with the rotation angle fixed. On this occasion, the slide of the first actuator 161 is guided by a guide rib 110C provided on the inner wall surface of the case 110 on the positive X-axis side. At that time, the first actuator 161 gradually comes away downward from the first shanks 112C of the cover 112 serving as its rotation center.

### Seventh State

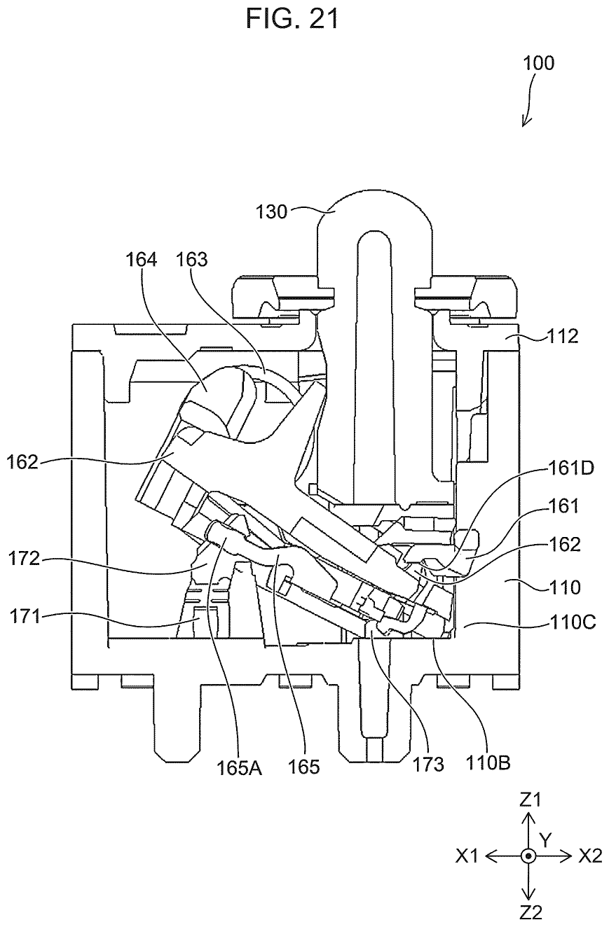

As illustrated in FIG. 21, when the slider 130 is pushed down until lower ends 130E of the slider 130 (see FIG. 4) and the bottom 110B of the case 110 come into contact, the downward slide of the slider 130 and the first actuator 161 In other words, FIG. 21 illustrate a state in which stops. the slider 130 is pushed downward most due to the overstroke of the slider 130.

When the pressing operation of the slider 130 is released thereafter, the slider 130 is pushed up by the cam 162 and the first actuator 161 due to the urging force from the torsion spring 163 to return to the initial position illustrated in FIG. 15.

### Eighth State

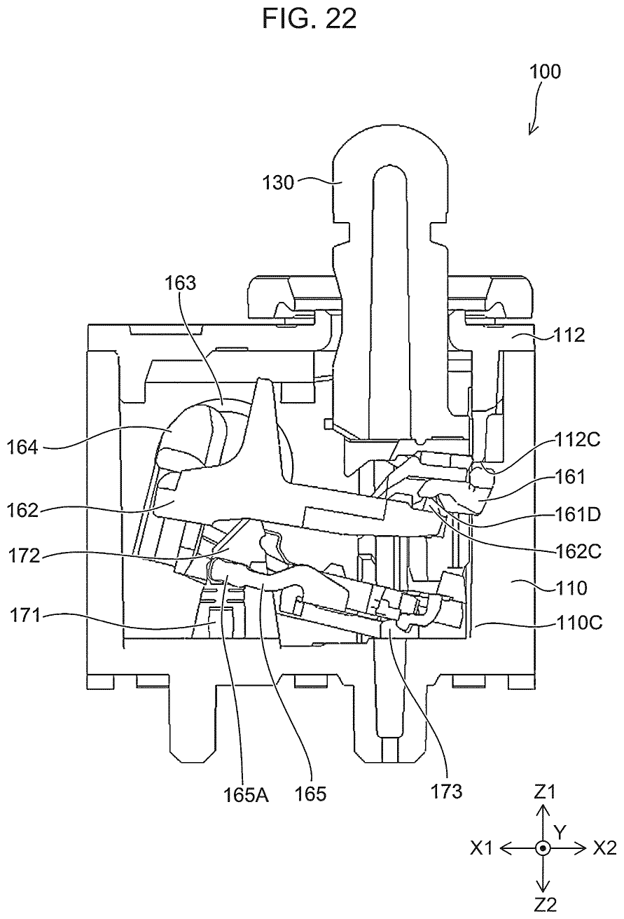

Specifically, as illustrated in FIG. 22, the cam lobe 162C of the cam 162 pushes the first actuator 161 upward using the urging force from the torsion spring 163 from the seventh state illustrated in FIG. 21. This causes the first actuator 161 to slide upward while pushing up the slider 130, with the rotation angle fixed. On this occasion, the slide of the first actuator 161 is guided by the guide rib 110C provided on the inner wall surface of the case 110 on the positive X-axis side. As illustrated in FIG. 22, when the first actuator 161 comes into contact with the first shanks 112C of the cover 112, the upward slide of the first actuator 161 stops.

### Ninth State

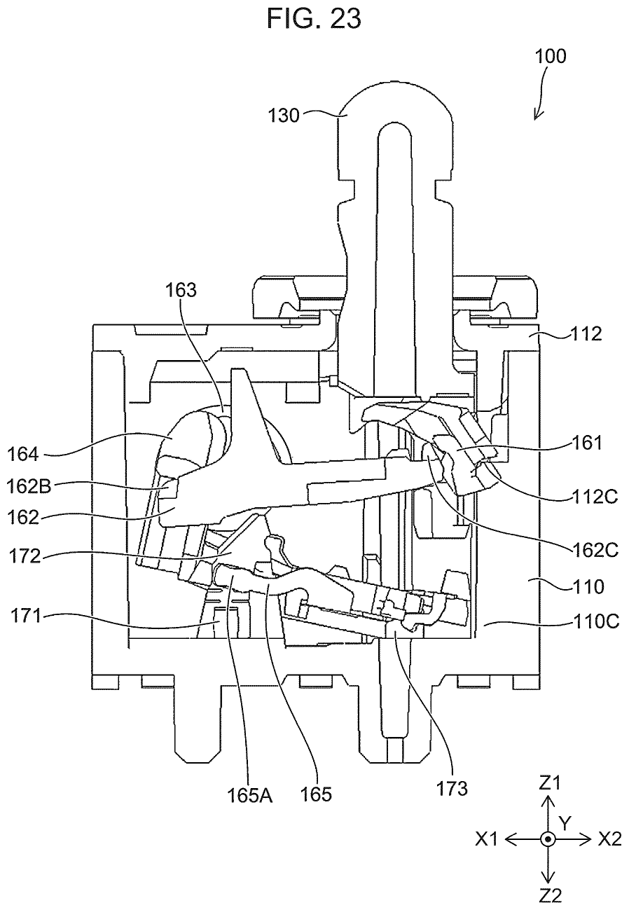

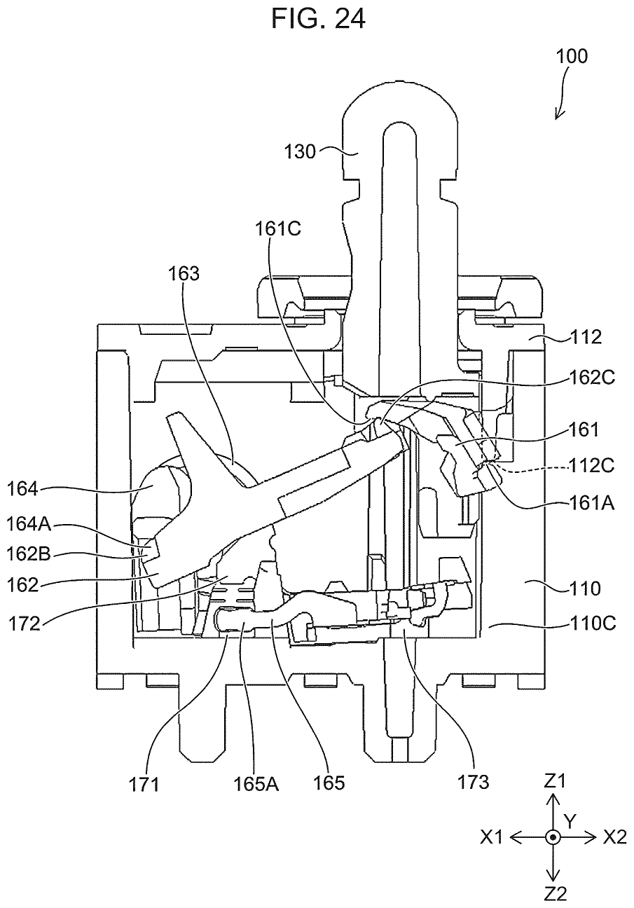

Thereafter, when the first actuator 161 is pushed up by the cam lobe 162C of the cam 162, as illustrated in FIG. 23, the first actuator 161 rotates upward while being journaled by the first shanks 112C of the cover 112 to push up the slider 130. The state in which the first actuator 161 is rotatably supported by the first shanks 112C of the cover 112 is illustrated in FIG. 24. The force of the cam lobe 162C of the cam 162 moving to slide up the lower inclined surface 161C of the first actuator 161 due to the urging force from the torsion spring 163 exceeds the frictional resistance between the cam lobe 162C and the lower inclined surface 161C. This causes the cam lobe 162C to instantly slide up over the lower inclined surface 161C toward the end of the lower inclined surface 161C. Consequently, the raising of the shaft 164A of the second actuator 164 by the rotary shaft 162B of the cam 162 is eliminated. In other words, the second actuator 164 instantly rotates downward about the contact point between the common contact portion 165B of the movable contact member 165 and the common contact member 173.

### Tenth State

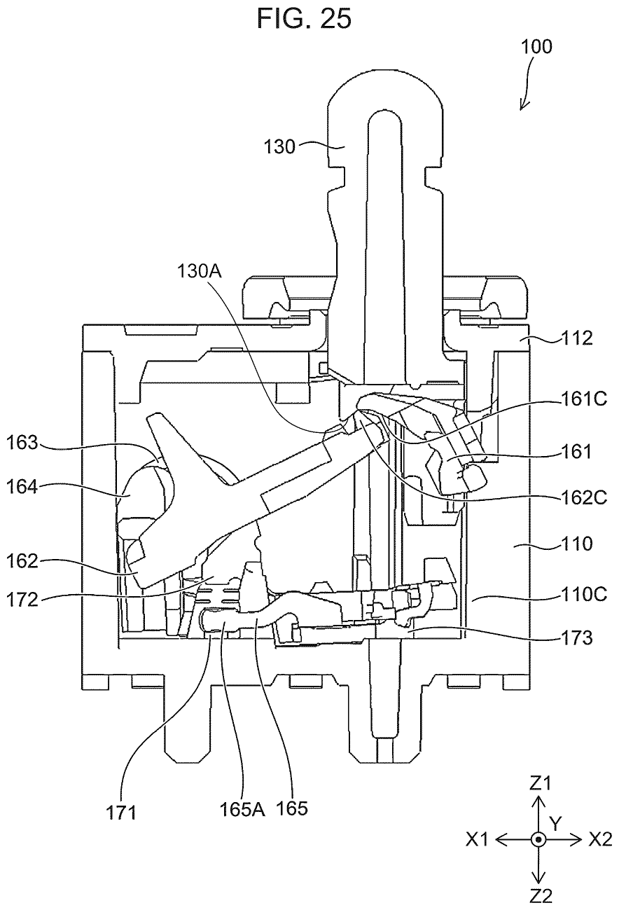

As illustrated in FIG. 25, when the second actuator 164 instantly rotates downward, the contact positions of the pair of contact pieces 165A of the movable contact member 165 held by the second actuator 164 instantly switch from the second contact points 172 to the first contact points 171. As a result, the first contact points 171 and the common contact member 173 are electrically connected via the movable contact member 165, in other words, the switching apparatus 100 is instantly switched to the first connection state. Thus, the switching apparatus 100, having a snap-action mechanism, enables instantaneous switching between the first connection state and the second connection state. When the contact position of the cam lobe 162C of the cam 162 switches from the lower inclined surface 161C of the first actuator 161 to the pressing surface 130A of the slider 130, as illustrated in FIG. 25, the upward rotation of the first actuator 161 ends, and the cam lobe 162C of the cam 162 urges the pressing surface 130A of the slider 130 upward to directly slide the slider 130 upward.

### Eleventh State

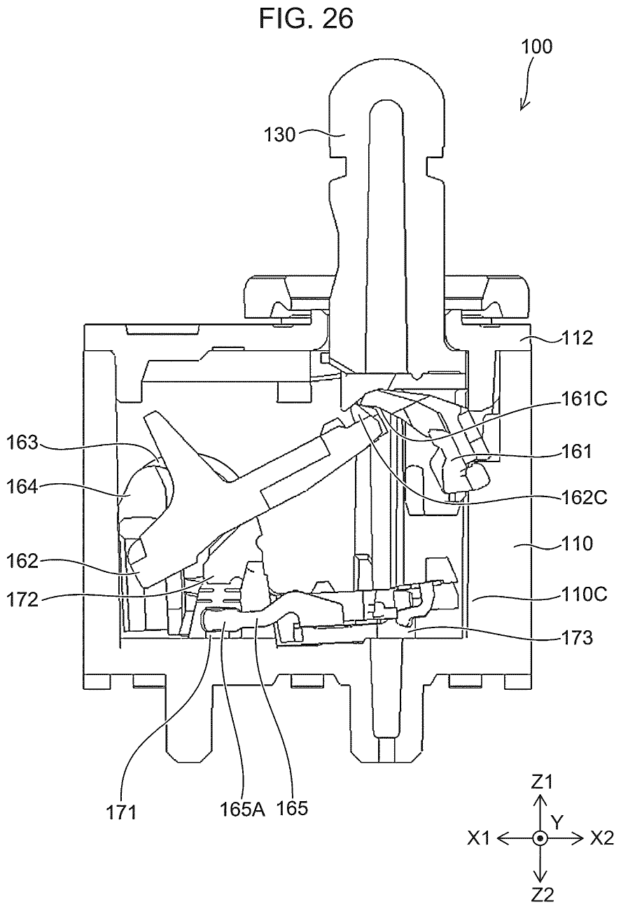

As illustrated in FIG. 26, when the slider 130 comes into contact with the lower surface of the cover 112, the upward slide of the slider 130 stops. In other words, FIG. 26 illustrates a state in which the slider 130 is pushed up most (the initial state).

According to the embodiments, a switching apparatus 100 configured to align the relative position of the switching contact member 170 and the movable contact members 165 easily and reliably can be provided.

Having described the embodiments, it is to be understood that the present invention is not limited to the above examples. It is to be understood that, for example, addition, deletion, or design changes of components performed by those skilled in the art on the above embodiments, as well as appropriate combinations of the features of the configurations of the embodiments, are also included within the scope of the present invention as long as they fall within the gist of the present invention.

What is claimed is:

1. A switching apparatus comprising:
a switching contact member including at least two contact points;
a common contact member;
a movable contact member disposed between the switching contact member and the common contact member and configured to electrically connect the switching contact member and the common contact member to each other; and
a holding member that holds the movable contact member,
wherein the movable contact member moves relative to the switching contact member to allow for switching between a first connection state and a second connection state,
wherein, in the first connection state, when a direction along a moving direction of the movable contact member is defined as a first direction, a direction along a direction in which the movable contact member extends and perpendicular to the first direction is defined as a second direction, and a direction perpendicular to both the first direction and the second direction is defined as a third direction,
the movable contact member includes:
a main body;
a pair of contact pieces provided at the main body, the contact pieces extending along the second direction and juxtaposed in the third direction so as to clamp the switching contact member; and
a common contact portion provided at a portion of the main body different from a portion where the pair of contact pieces is provided, the common contact portion coming into contact with the common contact member, and
the holding member includes a housing portion configured to house a housed portion of the main body,
wherein, when the housed portion is snap-fitted into the housing portion, the holding member restricts, for the main body, at least one of displacement in the first direction and displacement in the second direction while allowing a predetermined displacement in the third direction.

2. The switching apparatus according to claim 1,
wherein the holding member further includes a slit that restricts displacement of the main body in a moving direction of the housed portion when the housed portion is housed in the housing portion, and
wherein, when the housed portion is snap-fitted into the housing portion, with an insertion portion of the main body different from the housed portion inserted into the slit, the displacement of the main body in the first direction and the displacement in the second direction relative to the holding member are restricted.

3. The switching apparatus according to claim 1, wherein a moving direction of the housed portion when the housed portion is snap-fitted into the housing portion is along the first direction.

4. The switching apparatus according to claim 1, wherein a moving direction of the housed portion when the housed portion is snap-fitted into the housing portion is along the second direction.

5. The switching apparatus according to claim 1, further comprising an urging structure that urges the housed portion so as to come into elastic-contact with the housing portion, with the housed portion snap-fitted in the housing portion.

6. The switching apparatus according to claim 5, wherein the housed portion and the housing portion come into elastic-contact with each other along the first direction.

7. The switching apparatus according to claim 1,
wherein the holding member includes a plurality of the housing portions,
wherein the main body includes a plurality of the housed portions corresponding to the plurality of housing portions, and
wherein, when the plurality of housed portions is snap-fitted into the corresponding housing portions, the displacement of the main body relative to the holding member in the first direction and in the second direction is restricted.

8. The switching apparatus according to claim 1, wherein the holding member includes a restricting portion that restricts a range of displacement of the movable contact member relative to the holding member in the third direction.

9. The switching apparatus according to claim 8, wherein the restricting portion includes an intercalated portion positioned in a gap in the third direction between the pair of contact pieces.

10. The switching apparatus according to claim 5,
wherein the urging structure includes:
a protrusion provided at the holding member; and
an engaging piece provided at the main body and integrally connected to the housed portion, and
wherein the protrusion and the engaging piece are engaged with each other by movement of the housed portion when the housed portion is snap-fitted into the housing portion to cause elastic deformation of the engaging piece due to the protrusion, and the housed portion integrally connected to the engaging piece is urged in the first direction by the elastic deformation.

11. The switching apparatus according to claim 10,
wherein the protrusion includes an inclined surface, and
wherein the engaging piece slides along the inclined surface as the housed portion moves to be snap-fitted into the housing portion, increasing a degree of the elastic deformation of the engaging piece.

12. The switching apparatus according to claim 1, wherein, when the housed portion is snap-fitted into the housing portion, the main body preferentially undergoes elastic deformation.

13. The switching apparatus according to claim 12, wherein the movable contact member includes a metallic material with spring properties.

14. The switching apparatus according to claim 9, wherein the holding member holds a plurality of the movable contact members juxtaposed in the third direction.

15. The switching apparatus according to claim 1,
wherein the switching contact member includes two contact points independent from each other,
wherein the first connection state is a first conduction state in which one of the two contact points and the movable contact member are electrically connected, and
wherein the second connection state is a second conduction state in which another of the two contact points and the movable contact member are electrically connected.

16. The switching apparatus according to claim 15, further comprising a snap-action mechanism.

17. The switching apparatus according to claim 1,
wherein the first connection state is a conduction state in which there is an electrical connection with a contact point provided on the movable contact member, and
wherein the second connection state is a non-conduction state in which there is no electrical connection with the contact point.
